(19) United States
(12) Patent Application Publication
(10) Pub. No.: US 2006/0067388 A1
(43) Pub. Date: Mar. 30, 2006

(54) Methods and apparatuses for detecting impulse noise in a multi-carrier communication system

(76) Inventor: Hossein Sedarat, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/956,201

(22) Filed: Sep. 30, 2004

(51) Int. Cl. H04B 1/38

(52) U.S. Cl. 375/219

(57) ABSTRACT

Embodiments of an apparatus, system, and method are described for a multi-carrier communication system that detects for impulse noise present on a transmission medium. Values of peak error samples may be measured to determine an approximate magnitude of the average peak error samples present on a transmission medium. An average error value of all of the error samples may be measured to determine a standard deviation of a Gaussian distribution of background noise. An amount of peak error samples may be compared to a threshold value that is based upon a standard deviation derived from the background noise to determine if impulse noise is present on a particular tone.

### TECHNICAL FIELD

Embodiments of the present invention pertain to the field of communication systems and, more particularly, to multi-carrier communication systems.

### BACKGROUND

A multi-carrier communication system, such as a Discrete Multiple-Tone (DMT) system in the various types of Digital Subscriber Line (e.g. ADSL and VDSL) systems, carries information from a transmitter to a receiver over a number of tones. Each tone may be a group of one or more frequencies defined by a center frequency and a set bandwidth. The tones are also commonly referred to as sub-carriers or sub-channels. Each tone acts as a separate communication channel to carry information between a local transmitter-receiver device and a remote transmitter-receiver device.

DMT communication systems use a modulation method in which the available bandwidth of a communication loop, such as twisted-pair copper media, is divided into these numerous sub-channels. A communication loop may also be known as a communication channel. However, to avoid confusion, the term channel is used herein in reference to tones and frequencies, rather than transmission medium. The term communication loop is understood to refer generally to a physical transmission medium, including copper, optical fiber, and so forth, as well as other transmission mediums, including radio frequency (RF) and other physical or non-physical communication signal paths.

There are various sources of interference and noise in a multi-carrier communication system. Interference and noise may corrupt the data-bearing signal on each tone as the signal travels through the communication loop and is decoded at the receiver. The transmitted data-bearing signal may be decoded erroneously by the receiver because of this signal corruption.

In order to account for potential interference on the transmission line and to guarantee a reliable communication between the transmitter and receiver, each tone can merely carry a limited number of data bits per unit time. This number is related to a bit error rate (BER) for a given tone. The number of data bits or the amount of information that a tone carries may vary from tone to tone and depends on the relative power of the data-bearing signal compared to the power of the corrupting signal on that particular tone. The number of bits that a specific tone may carry decreases as the relative strength of the corrupting signal increases.

It is often assumed that the corrupting signal is an additive random source with Gaussian distribution and white spectrum. With this assumption, the number of data bits that each tone can carry relates directly to the signal-to-noise power ratio (SNR). This assumption may not be true in many practical cases and there are various sources of interference that do not have a white, Gaussian distribution. Impulse noise is one of those noise sources. Bit-loading algorithms, which are methods to determine the number of bits per tone, are usually design based on the assumption of additive, white, Gaussian noise. With such algorithms, the effects of impulse noise are underestimated resulting in an excessive rate of error.

There are some methods to combat impulse noise, like Reed-Solomon coding for forward error correction. The use and the parameters of this type of coding should depend on the existence and the relative power of impulse noise. Reed-Solomon coding for forward error correction corrects at the receiver but has a high latency due to a typical interleaving of multiple frames of data. The high latency and complexity make this impulse noise solution not suitable for certain applications.

### SUMMARY

Embodiments of an apparatus, system, and method are described for a multi-carrier communication system that detects for impulse noise present on a transmission medium. Values of peak error samples may be measured to determine an approximate magnitude of the average peak error samples present on a transmission medium. An average error value of all of the error samples may be measured to determine a standard deviation of a Gaussian distribution of background noise. An amount of peak error samples may be compared to a threshold value that is based upon a standard deviation derived from the background noise to determine if impulse noise is present on a particular tone.

Other features and advantages of the present invention will be apparent from the accompanying drawings and the detailed description that follows.

### BRIEF DESCRIPTION OF THE DRAWINGS

Embodiments of the present invention are illustrated by way of example and are not intended to be limited by the figures of the accompanying drawings, in which:

FIG. 1 illustrates a block diagram of an embodiment of a discrete multiple tone system that detects for impulse noise present on the transmission medium.

FIG. 2 illustrates an example scatter plot of a Quadrature Amplitude Modulation (QAM) constellation of detected error samples.

FIG. 3a shows an example scatter plot of a distribution of an aggregate of all error samples for a particular tone.

FIG. 3b illustrates an example histogram representative of the Gaussian distribution of error samples solely from the background noise illustrated in FIG. 3a.

FIG. 4 illustrates an example error scatter plot when both Gaussian background and impulse noise sources are present on the transmission medium.

FIG. 5 illustrates a histogram representative of the Gaussian mixture distribution of the error samples from both background noise and impulse noise illustrated in FIG. 4.

FIG. 6 illustrates a table showing example values of the probability of having a peak error sample/outlier with a magnitude greater than a threshold for a unit-power Gaussian source with and without an impulse noise present on the transmission medium.

FIGS. 7a-7c illustrate a flow chart of an embodiment of detecting for the presence of impulse noise on a transmission medium.

### DETAILED DESCRIPTION

In the following detailed description, numerous specific details are set forth in order to provide a thorough understanding of the invention. However, it will be understood by those skilled in the art that certain embodiments of the present invention may be practiced without these specific details. In other instances, well-known methods, procedures, components, and circuits have not been described in detail so as not to obscure the presented embodiments of the invention. The following detailed description includes several modules, which will be described below. These modules may be implemented by hardware components, such as logic, or may be embodied in machine-executable instructions, which may be used to cause a general-purpose or special-purpose processor programmed with the instructions to perform the operations described herein. Alternatively, the operations may be performed by a combination of hardware and software.

Apparatuses, systems, and methods are described for a multi-carrier communication system that detects for impulse noise present on a transmission medium. In an embodiment, a training period is established between a first transmitter-receiver device and a second transmitter-receiver device in the discrete multiple tone system that separates communication signals into two or more separate frequency bands. Impulse noise generated by various elements present on the transmission medium, such as a telephone line, is detected during the training period. The significance of the impulse noise contribution to the overall ambient noise level present in the system may be determined.

A transmitter-receiver device may detect for impulse noise present in a multiple tone system by performing the following steps. The transmitter-receiver device may measure values of detected peak error samples to determine an approximate magnitude, i.e. amplitude in voltage and/or power, of the average peak error samples present on a transmission medium. The transmitter-receiver device may measure an average error value of all of the detected error samples to determine a standard deviation of a Gaussian distribution of background noise. The transmitter-receiver device may compare an amount of peak error samples to a threshold value. The threshold value is based upon a standard deviation derived from the Gaussian distribution of background noise. The comparison may determine if impulse noise is present on a particular tone. The transmitter-receiver device may determine if the presence of impulse noise is detected on two or more tones transmitted on a same transmission medium, and then declare that an impulse noise source is associated with the transmission medium rather then a particular tone.

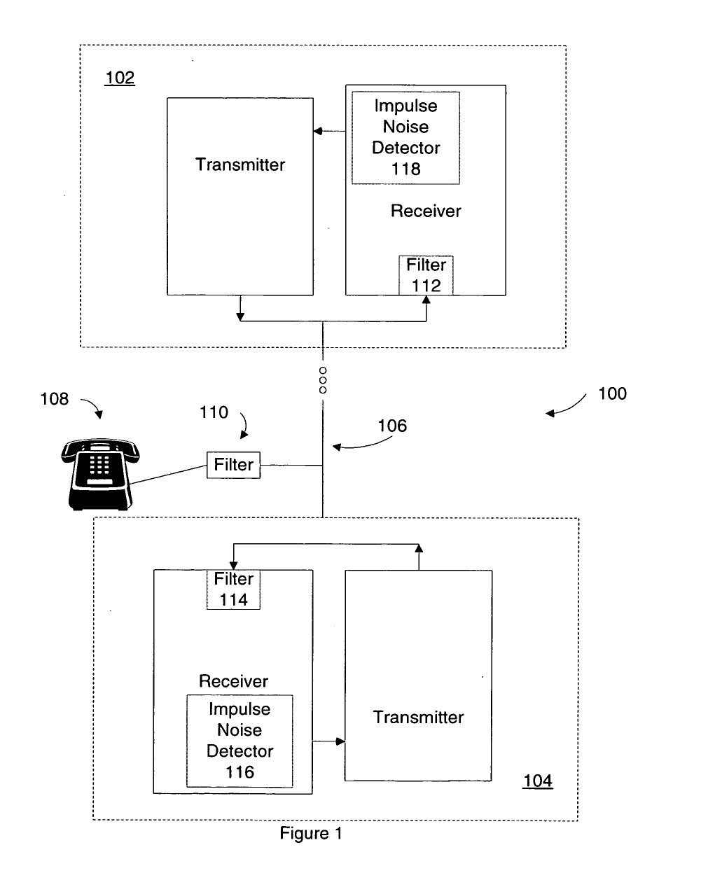

FIG. 1 illustrates a block diagram of an embodiment of a discrete multiple tone system that detects for impulse noise present on the transmission medium. The discrete multiple tone system 100, such as a Digital Subscriber Line (DSL) based network, may have two or more transmitter-receiver devices 102, 104, such as a set top box. The first transmitter-receiver device 102, such as a Discrete Multi-Tone transmitter, transmits and receives communication signals from the second transmitter-receiver device 104 over a transmission medium 106, such as a telephone line. Other devices such as telephones 108 may also connect to this transmission medium 106. An isolating filter 110 generally exists between the telephone and the transmission medium 106. A training period occurs when initially establishing communications between the first transmitter-receiver device 102 and a second transmitter-receiver device 104.

The discrete multiple tone system 100 may include a central office, multiple distribution points, and multiple end users. The central office may contain the first transmitter-receiver device 102, such as a modem, that communicates with the second transmitter-receiver device 104 at an end user's location.

Each transmitter portion of the transmitter-receiver device 102, 104 may transmit data over a number of mutually independent sub-channels i.e. tones. Each sub-channel carries only a certain portion of data through Quadrature Amplitude Modulation (QAM) of the sub-carrier. The number of information bits loaded on each tone and the size of corresponding QAM constellation may potentially vary from one tone to another and depend generally on the relative power of signal and noise at the receiver. When the characteristics of signal and noise are known for all tones, a bit-loading algorithm can determine the optimal distribution of data bits and signal power amongst sub-channels. Thus, the transmitter portion of the transmitter-receiver device 102, 104 modulates each sub-carrier with a data point in a QAM constellation.

Each transmitter-receiver device also includes a receiver portion that contains a noise detector 116, 118. Each noise detector 116, 118 may contain software and/or logic programmed to detect for the presence of impulse noise present in the system. Each noise detector 116, 118 may detect an error difference between an amplitude of each transmitted data point in the QAM constellation and an expected amplitude for each data point in the QAM constellation. Each noise detector 116, 118 may detect for the presence of impulse noise based on the error difference detected between the received data point and expected data point. Impulse noise generally has a short period and large magnitude, i.e. spikes, compared to the background noise. The error difference for each transmitted data point may be known as an error sample.

The training protocol may dictate the transmission of long strings of transmitted data points to assist in determining the noise present on the transmission medium. Each noise detector 116, 118 calculates a power of the error samples on each tone, for instance, by averaging the second power of error samples. Each noise detector 116, 118 may set a magnitude threshold for the error samples for each tone based upon a standard deviation for average power of a Gaussian distribution of error samples of noise on that tone. Each noise detector 116, 118 may count the number of error samples with a magnitude greater than the magnitude threshold value that is based upon the standard deviation derived from the Gaussian distribution of background noise. Thus, each error sample with either a positive or a negative amplitude having an absolute value greater than the magnitude threshold value is counted. The threshold may be set by the designer or user to be a factor of one or more times the calculated value of the standard deviation.

Each noise detector 116, 118 may calculate the frequency of the error samples with the magnitude greater than the threshold by dividing the number of error samples with the magnitude greater than the threshold over a total number of error samples detected. Each noise detector 116, 118 may determine if the frequency of error samples with the magnitude greater than the threshold is higher than a set point. If the frequency of error samples is higher than the set point then an impulse noise is determined to be present on that particular tone. The designer or user may establish the set point. Each noise detector 116, 118 may determine if a number of tones, that may or may not data bearing, having impulse noise present is greater than a tone count threshold, such as twenty percent of the tones, then the noise detector 116, 118 declares that an impulse noise source is associated with the transmission medium 106 rather then just a few tones.

As discussed, the receiver detects the transmitted data point with some distance from the expected constellation point because of the noise and other sources of interference. In order to avoid error in decoding data, the demodulated point should not pass the so-called decision boundary. A decision boundary is a midway border between neighboring constellation points. Given the probability distribution of the noise, the noise detector 116, 118 can calculate the minimum distance between constellation points such that the probability of error is less than some target value. When the power of noise is low, the minimum distance can be chosen to be small. This results in a denser constellation that carries more data bits.

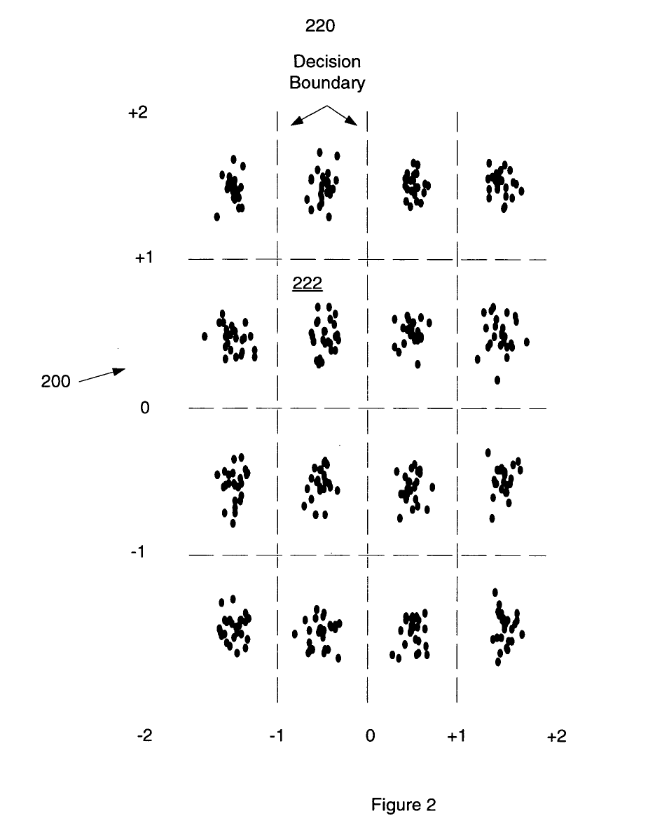

FIG. 2 illustrates an example scatter plot of a QAM constellation of detected error samples. The transmit data in a multicarrier system is usually represented by a point from a constellation of finite set of possible data points, regularly distributed over a two dimensional space. The set of detected error samples in this example were chosen from a set of 16 data points in a QAM constellation 200. Thus, the QAM constellation grid 200 represents sixteen different possible data values that could be carried by that tone.

The transmitted data point is located at the center of each cell bounded by the decision boundaries 220. For example, a first cell 222 with an expected transmitted data point having coordinates of (−0.5, +0.5). If there is no noise or other sources of error, the received data point will coincide with the transmit point located at the center of each cell bounded by the decision boundaries 220.

The dashed lines indicate decision boundaries 220 for the QAM constellation grid 200 of potential data values. The dots are the received or detected data points. Their distance to the expected data points located at the center of the corresponding cell represents an error sample. For example, the first cell 222 contains a distribution of error samples.

The center coordinates of a particular cell for example, (−0.5, +0.5) for the first block 222, represent the expected amplitude and phase of the transmitted data for that data point. A transmitted data point within the boundaries of a given cell allows that transmitted data point to be correlated to the data value associated with that cell. However, because of noise error present in the system, the received data point may be decoded with some distance from the expected transmitted point. The distance from the expected transmitted point, for example the center of the first block 222 coordinates −0.5, +0.5, to the actual coordinates of the dots in that cell represent the detected error in the system.

The distance between the received samples and the actual transmitted data points represents the error of detection. The error of detection is based on the noise and other sources of error present in the system.

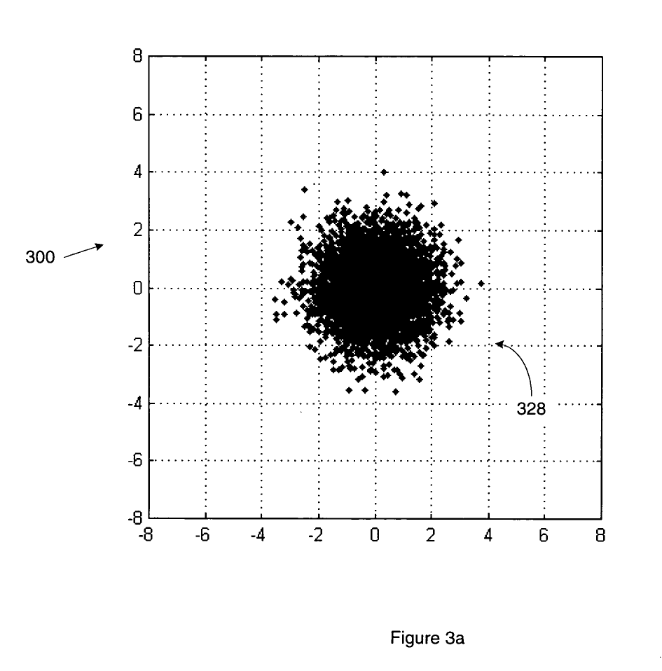

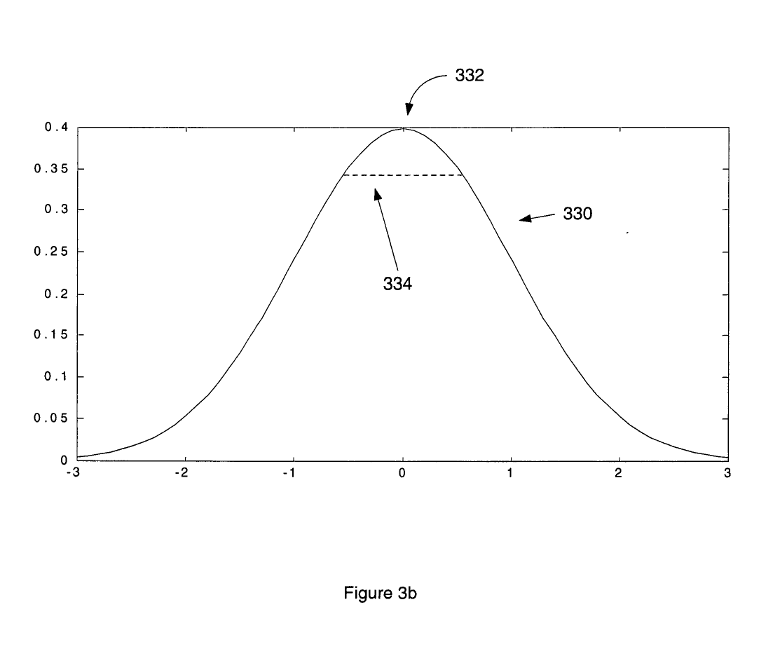

FIG. 3a shows an example scatter plot of a distribution of an aggregate of all error samples for a particular tone. The scatter plot 300 displays error samples 328 on perpendicular axes with coordinates at the center of the block being the expected amplitude of the transmitted data points in the training signal. When the source of error is solely an additive white Gaussian noise, then the values of error samples 328 in each direction have a Gaussian distribution. The scatter plot shows the aggregate of error samples for all of the data points in the QAM constellation. The noise source in this plot is a Gaussian noise source of unit power. Each marked point in this plot represents a detected data point at the receiver. The distance of these points from the center shows the detection error. The cluster of error samples 328 at the center has a Gaussian distribution and represents the detection error due to the background noise when there is no impulse interference. The density of error samples decreases as the magnitude of the error sample increases away from the expected transmitted data point.

FIG. 3b illustrates an example histogram representative of the Gaussian distribution of error samples solely from the background noise illustrated in FIG. 3a. The Gaussian distribution of the error samples 330 from solely background noise has an amplitude 332 highest closest to the expected transmitted data point, i.e. coordinates 0,0. The amplitude of the distribution of error samples decreases as the magnitude of the error sample increases away from the expected transmitted data point. The Gaussian distribution of the error samples 330 from solely background noise will have a given power level associated with that Gaussian distribution of the error samples. The Gaussian distribution of the error samples 330 will also have a standard deviation derived 334 from the Gaussian distribution of background noise equal to the square root of the average power level.

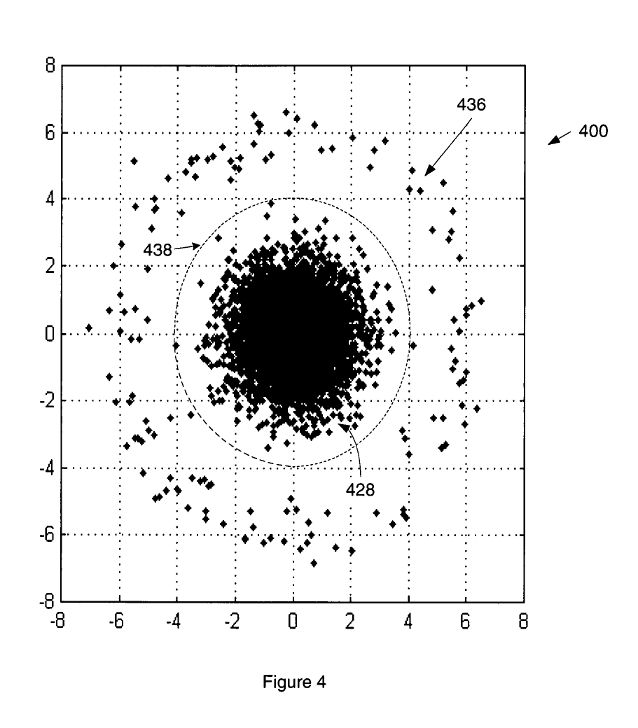

FIG. 4 illustrates an example error scatter plot when both Gaussian background and impulse noise sources are present on the transmission medium. The error scatter plot 400 illustrates a Gaussian mixture distribution of an aggregate of all of the error samples for a particular tone. The error scatter plot 400 shows an aggregate from all of the QAM cells. The cluster of points at the center shows the effect of Gaussian background noise 428 when the impulse noise source is not active on the transmission medium. The peak error samples 436, which form an outlying ring of points in the scatter plot, consists of detected error samples received during the active intervals of the impulse noise. Impulse noise, if present, shifts the distribution of error points away from the target distribution coordinates of (0, 0) to create a second Gaussian distribution plot. The outer ring made up of peak error samples 436 in the scatter plot shows the error introduced to the transmitted training signal due to impulse interference and Gaussian background noise combined.

The value of impulse noise during active periods may be represented by an impulse magnitude and an impulse phase. A simple model for impulse noise assumes a uniform distribution for impulse phase and a Gaussian distribution for its magnitude.

A magnitude threshold value 438 may be established that is based upon a multiplication factor of one or more standard deviations derived from the power level of the Gaussian distribution of background noise 428. The number of peak error samples 436 with a magnitude greater than the magnitude threshold value 438 may be determined. The values of detected peak error samples 436 may be measured to determine an approximate magnitude of the average peak error samples 436 present on a transmission medium. The approximate magnitude of the average peak error samples 436 may be quantified to be the absolute value of the voltage and/or power of those peak error samples. An overall measurement of the average error value of all of the detected error samples may be made, including the peak error samples 436 from the outer ring and the background noise error samples 428 from the center. A comparison may be made of the amount of peak error samples 436 to the magnitude threshold value 438 that is based upon a standard deviation derived from the Gaussian distribution of background noise 428. The comparison may determine if impulse noise is present on a that particular tone.

The frequency of outlying peak error samples 436 is directly related to the frequency of impulse noise. In DSL systems, a prevalent source of impulse interference is dimmer light switches or any other switches that periodically turns the AC power on and off. In such cases, the frequency of impulse is a multiple of the frequency of AC power source. This frequency is much higher than what a Gaussian distribution from a background noise source can generate.

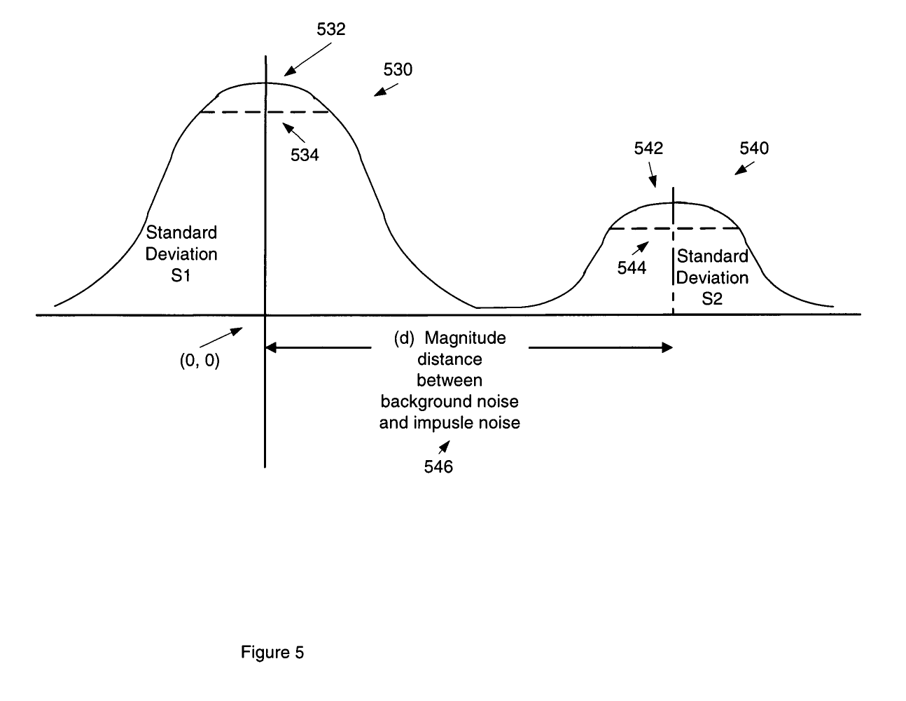

FIG. 5 illustrates a histogram representative of the Gaussian mixture distribution of the error samples from both background noise and impulse noise illustrated in FIG. 4. A simple noise model may combine the effects of the background Gaussian noise and the impulse noise. The Gaussian mixture distribution of the error samples has two Gaussian distribution curves. One curve is a Gaussian distribution of peak error samples 540, which are indicative of impulse error samples. The second is a Gaussian distribution of background noise error samples 530. Both Gaussian distribution curves 530, 540 have a magnitude 532, 542 associated with that curve. The Gaussian distribution of background noise error samples is 532 highest closest to the expected transmitted data point, i.e. coordinates 0,0. The impulse noise, if present, shifts the distribution of error points away from the target distribution coordinates of (0, 0) to create the second Gaussian distribution curve 540. The distance (d) 546 between the center points of both curves corresponds to the average amplitude of the peak error samples compared to the expected data points. Both the Gaussian distribution curve of background noise error samples 530 and the Gaussian distribution curve of peak error samples 540 have a standard deviation 534, 544 approximately equal to the square root of the power level of that Gaussian distribution curve.

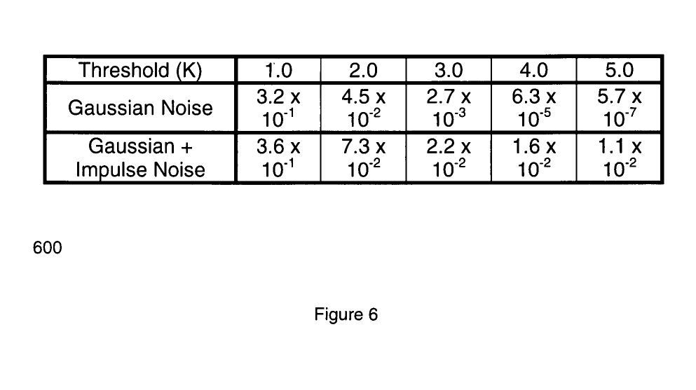

FIG. 6 illustrates a table showing example values of the probability of having a peak error sample/outlier with a magnitude greater than a threshold for a unit-power Gaussian source with and without an impulse noise present on the transmission medium. The table 600 shows the threshold value (K) is set in this example as a multiplication factor of one or more standard deviations derived from the power level of the Gaussian distribution of background noise. Thus, five different threshold settings are shown, one times the standard deviation value through five times the standard deviation value. A certain probability exists for each threshold whether the magnitude of a particular error sample will be greater than the threshold. This probability is several orders of magnitude higher with an impulse interferer for certain values of threshold. This is the salient feature that distinguishes impulse noise from a pure Gaussian noise source. For example, the magnitude threshold value may be set at three times the standard deviation value. 0.27 percent of the error samples will have magnitudes that exceed the threshold value (K) of 3× the standard deviation if only back ground noise is present in the system. In contrast 2.2 percent of the error samples will have magnitudes that exceed the threshold value (K) of 3× the standard deviation if impulse noise is present in the system. Thus, if impulse noise is present, it is 10 times more probable that a peak error sample will be measured with magnitude over 3× the standard deviation than if merely background noise is present on the transmission medium. The threshold value can be set to establish an X percent probability exists whether an error sample is a peak error sample or not.

Similarly, the magnitude threshold value (K) may be set at five times the standard deviation value. Virtually none of the error samples, 5.7×10⁻⁷, will have magnitudes that exceed the threshold value of 5× the standard deviation if only back ground noise is present in the system. In contrast, 1.1 percent of the error samples will have magnitudes that exceed the threshold value of 5× the standard deviation if impulse noise is present in the system. Thus, if impulse noise is present, it is approximately 20,000 times more probable that a peak error sample will be measured than if merely background noise is present on the transmission medium.

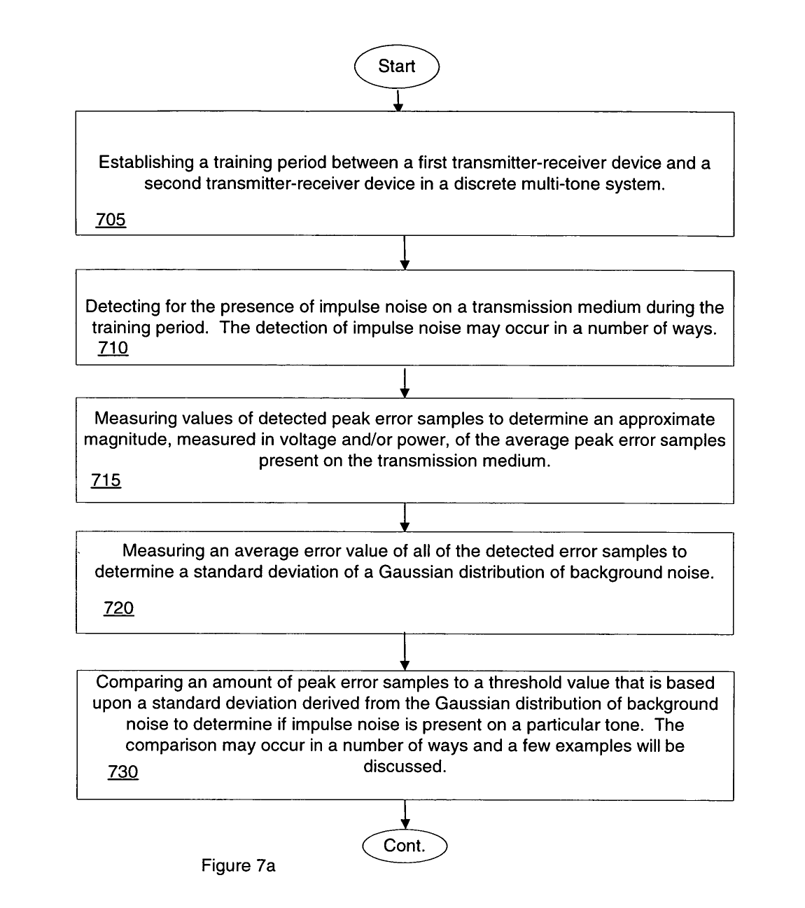

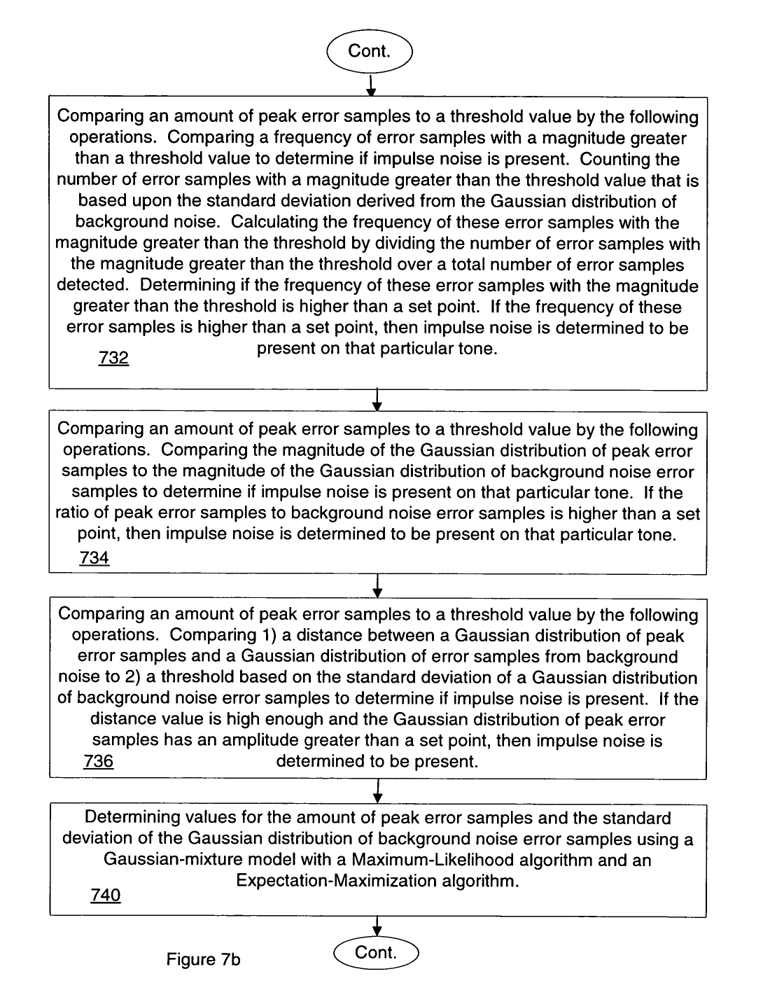

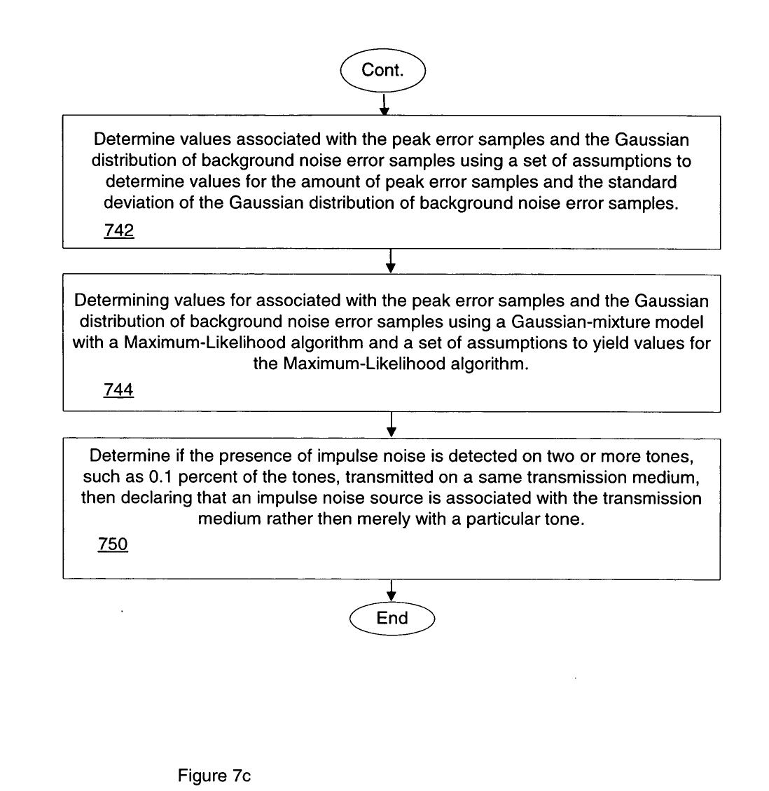

FIGS. 7a-7c illustrate a flow chart of an embodiment of detecting for the presence of impulse noise on a transmission medium. A device may perform the following operations for a particular tone in the multiple tone system and then repeat these operations for every tone in the multiple tone system.

In block 705, a training period between a first transmitter-receiver device and a second transmitter-receiver device in the discrete multiple tone system may be established.

In block 710, a transmitter-receiver device may detect for the presence of impulse noise on a transmission medium during the training period. The detection may occur in a number of different ways. A few example ways are described below.

In block 715, a transmitter-receiver device may measure values of detected peak error samples to determine an approximate magnitude, measured in voltage and/or power, of the average peak error samples present on the transmission medium.

In block 720, a transmitter-receiver device may measure an average error power value of all of the detected error samples to determine a standard deviation of a Gaussian distribution of background noise.

In block 730, a transmitter-receiver device may compare an amount of peak error samples to a threshold value that is based upon a standard deviation derived from the Gaussian distribution of background noise to determine if impulse noise is present on a particular tone. The comparison may occur in a number of ways and a few examples will be discussed. In an embodiment, if the comparison on any of the detection methods is not high enough in magnitude, then impulse noise is not present in that tone.

In block 732, a transmitter-receiver device may compare an amount of peak error samples to a threshold value by the following operations. A transmitter-receiver device may compare a frequency of error samples with a magnitude greater than a threshold value to determine if impulse noise is present. The transmitter-receiver device counts the number of error samples with a magnitude greater than the threshold value that is based upon the standard deviation derived from the Gaussian distribution of background noise. The transmitter-receiver device calculates the frequency of these error samples with the magnitude greater than the threshold by dividing the number of error samples with the magnitude greater than the threshold over a total number of error samples detected. The transmitter-receiver device may determine if the frequency of these error samples with the magnitude greater than the threshold is higher than a set point. If the frequency of these error samples is higher than a set point, then impulse noise is determined to be present on that particular tone.

In block 734, a transmitter-receiver device may compare an amount of peak error samples to a threshold value by the following operations. A transmitter-receiver device may compare the magnitude of the Gaussian distribution of peak error samples to the magnitude of the Gaussian distribution of background noise error samples to determine if impulse noise is present on that particular tone. If the ratio of peak error samples to background noise error samples is higher than a set point, then impulse noise is determined to be present on that particular tone.

In block 736, a transmitter-receiver device may compare an amount of peak error samples to a threshold value by the following operations. A transmitter-receiver device may compare 1) a distance between a Gaussian distribution of peak error samples and a Gaussian distribution of error samples from background noise to 2) a threshold based on the standard deviation of a Gaussian distribution of background noise error samples to determine if impulse noise is present. If the distance value is high enough and the Gaussian distribution of peak error samples has an amplitude greater than a set point, then impulse noise is determined to be present.

In block 740, a transmitter-receiver device may determine values for the amount of peak error samples and the standard deviation of the Gaussian distribution of background noise error samples using a Gaussian-mixture model with a Maximum-Likelihood algorithm and an Expectation-Maximization algorithm. A Gaussian-mixture model, which incorporates data from histograms of two Gaussian distribution plots of error samples, may be used with a 1) Maximum-Likelihood algorithm and 2) an Expectation-Maximization algorithm. The Maximum-Likelihood algorithm is used to determine what are the best values for the parameters of the Gaussian mixture distribution that would generate the measured samples with highest probability. Expectation-Maximization is an iterative mechanism to solve for the values for the Maximum-Likelihood algorithm.

Accordingly, one method to model the combination of impulse and Gaussian background noise is to use a Gaussian-mixture model. In this model, the probability distribution function is a combination of two Gaussian functions. One Gaussian distribution function represents the background noise when the impulse noise is inactive. Another Gaussian distribution function represents the overall background and impulse noise. This latter distribution is conditionally Gaussian with the power of background noise and an average of the amplitude peak error sample, i.e. impulse noise. The impulse noise itself can be modeled as random variable with uniform distribution on its phase and another proper distribution (like Gaussian with non-zero average) for its amplitude.

The parameters of this Gaussian-mixture model can be derived from a set of measurements through various algorithms such as 1) Maximum-Likelihood and 2) Expectation-Maximization, to name a few.

The simple principle of Maximum Likelihood parameter estimation is this: find the parameter values that make the observed data most likely. There are certain laws of probability that allow the logic to make inferences and predictions based on probabilistic information. The Maximum Likelihood estimation algorithm begins with writing a mathematical expression known as the Likelihood Function of the sample data. Loosely speaking, the likelihood of a set of data is the probability of obtaining that particular set of data, given the chosen probability distribution model. This expression contains the unknown model parameters. The values of these parameters that maximize the sample likelihood are known as the Maximum Likelihood Estimators.

An Expectation-Maximization algorithm (EM) is an iterative optimization method to estimate some unknown parameters, given measurement data. EM wants to maximize the posterior probability of the parameters given the data marginalizing over a distribution plot.

Maximum-Likelihood determines what the best values should be for: the magnitude of impulse noise (d); the standard deviation of Gaussian distribution of background noise; and the standard deviation of impulse noise based on probabilities. Expectation-Maximization solves for these parameters given the measurement data.

In block 742, a transmitter-receiver device may determine values associated with the peak error samples and the Gaussian distribution of background noise error samples using a set of assumptions to determine values for the amount of peak error samples and the standard deviation of the Gaussian distribution of background noise error samples.

The above Maximum Likelihood and Expectation-Maximization analysis can be simplified significantly with the four reasonable assumptions.

First, the impulse noise activation frequency is much higher than the target error rate. Thus, the error events are most dominantly generated by the spikes from the impulse noise rather than the Gaussian distribution of background noise.

Second, the average value of impulse noise amplitude is much larger than the standard deviation of the Gaussian distribution of background noise, which allows a reasonable threshold to be set.

Third, the variation of the impulse amplitude is negligible comparing to the background noise, which means a narrow ring distribution of peak error samples with a magnitude greater than the threshold.

Fourth, the impulse noise has a very small duty cycle, i.e. short burst occurring merely for a small period in time, which allows an average power for whole distribution of noise to be based on the distribution of error samples for solely the Gaussian background noise source.

With these assumptions, the peak error samples/outliers in the scatter plot dominate the error events. Therefore, for the sake of error-rate analysis and bit-loading, the transmitter receiver can limit its consideration to these peak error data points. Given the value of impulse noise, these peak error points have a biased-Gaussian distribution with a mean value equal to the impulse amplitude and a standard deviation identical to that of background Gaussian noise. These two parameters can be measured as the peak and average (standard deviation or root-mean-square) of the error values, respectively.

From these assumptions, the transmitter receiver can also measure the power of background noise by calculating the power of error samples. Moreover, the peak value of error samples also represents the amplitude of the impulse noise. Using the measured value for power, the transmitter receiver can identify a threshold above which the error samples are labeled as peak error samples/outlying data points. If the frequency of occurrence of the peak error samples is high enough, then a periodic impulse noise is detected on the transmission medium.

An example detection algorithm may be as follows. For each tone t denote the n^{th} error measurement as eₙ(t).

The detection algorithm may calculate the power of error on each tone, for instance, by averaging the second power of error samples with the equation below. This calculation sums the squared value of all error samples taken and divides by the number of error samples taken. This calculates average power for whole error sample distribution using the assumption that the impulse noise has a very small duty cycle. The average power of a tone, e²(t) is:

$$\overline{{e}^{2} ( t )} = \frac{1}{N} {\sum }_{n = 1}^{N} {e}_{n}^{2} ( t )$$

The detection algorithm may set the threshold for peak error samples/outliers with the equation below. Tₐ(t) is the amplitude threshold for detected error points for each t tone.
Tₐ(t)=Kₒ\sqrt{e²(t)},

where Kₒ is a constant scale factor from table 6. The square root function provides the standard deviation for average power of the Gaussian distribution of error samples from background noise determined in the step above. In an embodiment, the Kₒ factor is set to 4. Thus, the threshold is set at 4× the standard deviation for average power of the Gaussian distribution of error samples from background noise.

The detection algorithm may count the error samples Nₒ(t) with magnitude greater than the threshold set for that tone with the equation below. The magnitude of the error measurement for a tone corresponds to the absolute value of amplitude of the error measurement for that tone.
Nₒ(t)=number of error samples with |eₙ(t)|>Tₐ(t)

This assumes that the average value of impulse noise amplitude is much larger than the standard deviation of the Gaussian distribution of error samples from background noise.

The detection algorithm may calculate the relative frequency of peak error samples/outlying data points Fₒ(t) with the equation below.

$${F}_{0} ( t ) = \frac{{N}_{0} ( t )}{N}$$

Where the Nₒ(t) total number of detected error points that exceed the threshold over the total number (N) of detected error points.

If the frequency of peak error samples is greater than a threshold T_{F} label the tone as a tone effected by impulsive noise. In an embodiment, this threshold is set to 0.001 and determines whether a tone has impulse noise present on the transmission medium.

If the number of impulsive tones (that may or may not data bearing) is greater than a threshold Tₜ, declare a detected impulse noise on the transmission medium. In an embodiment, this threshold is set to 2% of the total tones. This determines that a transmission medium has an impulse noise source present based upon if enough tones on a particular transmission medium have impulse noise present.

In block 744, a transmitter-receiver device may determine values for associated with the peak error samples and the Gaussian distribution of background noise error samples using a Gaussian-mixture model with a Maximum-Likelihood algorithm and a set of assumptions to yield values for the Maximum-Likelihood algorithm. The Maximum-Likelihood algorithm and set of assumptions determine the values for the amount of peak error samples and the standard deviation of the Gaussian distribution of background noise error samples. The four assumptions above may be used to yield the values for the Maximum-Likelihood algorithm.

In block 750, a transmitter-receiver device may determine if the presence of impulse noise is detected on two or more tones, such as one percent of the tones, transmitted on a same transmission medium, then declaring that an impulse noise source is associated with the transmission medium rather then merely with a particular tone.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

For example, a machine-readable medium may be provided having one or more instructions stored thereon, which instructions may be used to program a computer system or other electronic device to perform the operations described. A machine-readable medium may include any mechanism for storing or transmitting information in a form (e.g., software or processing application) readable by a machine (e.g., a computer). The machine-readable medium may include, but is not limited to, magnetic storage media (e.g., a floppy diskette), optical storage media (e.g., CD-ROM, CD-RW, DVD, etc.), magneto-optical storage media, read only memory (ROM), random access memory (RAM), erasable programmable memory (e.g., EPROM and EEPROM), flash memory, electrical, optical, acoustical, or other forms of propagated signal (e.g. carrier waves, infrared signals, digital signals, etc.), or other types of media suitable for storing electronic instructions.

The instructions and operations also may be practiced in distributed computing environments where the machine-readable media is stored on and/or executed by more than one computer system. In addition, the information transferred between computer systems may either be pulled or pushed across the communication media connecting the computer systems.

In general, although exemplary frequencies and tones are used in the description above, other frequencies, tones, and combinations thereof may be applicable to or affected by certain embodiments of the present invention.

Furthermore, referring to FIG. 1, although the communication system 100 is described above in the context of an ADSL system, the communication system 100 is representative of alternative types of communication systems, such as wireless radio frequency (RF), that may employ multi-carrier communication schemes to communicate data from a transmitter to a receiver.

In an embodiment, the transmitter-receiver device may take advantage of an extremely low noise, high linearity ADSL Analog Front End (AFE) and digital echo canceller, providing excellent long loop and bridge tap performance.

Thus, the transmitter-receiver device may reduce the need for a technician visit and provides superior modem training capability, particularly for those customers at the edge of the DSL coverage area.

The transmitter-receiver device may utilize impulse noise compensation and non-linear echo compensation to increase reliability and performance in actual ADSL end user environments. The transmitter-receiver device may detect real-world conflicts such as dimmer switches, fluorescent lighting, AM radio interference, unfiltered devices connected to the ADSL line (alarm systems, water meters, and half ringers) and poor wiring. This extra step ensures a better user experience, reduces truck rolls, and reduces lengthy troubleshooting calls.

In an embodiment, the transmitter-receiver device may also be a set top box that combines television (Internet Protocol TV or Satellite) with broadband Internet to bring the best of the airwaves and the Internet to an end user's TV set. The multiple carrier communication channel may communicate a signal to a residential home. The home may have a home network, such as an Ethernet. The home network may either use the multiple carrier communication signal directly or convert the data from the multiple carrier communication signal. The integrated Satellite and Digital Television Receiver, High-Definition Digital Video Recorder and Digital Media Server make this a powerful set top box. Multi-Room Entertainment Networking and compelling Broadband Media Services provide the easiest way for the entire family to enjoy the digital lifestyle.

IPTV, Satellite and Digital Television Receiver

MediaPortal is capable of receiving satellite and local off-air television programming in both high-definition (HD) and standard-definition (SD) formats. Multiple tuners coupled with the high-definition, high-capacity Digital Video Recorder allow you to watch and record up to 3 programs simultaneously. Enjoy the best picture and sound available through the HD video and Dolby® Digital 5.1 audio outputs.

High-Definition Digital Video Recorder (DVR)

MediaPortal records and stores up to 180 hours of SD programming, up to 25 hours of HD programming, or any combination of the two on its huge 250 GB hard disk drive. Watch live TV or select a show to record with a press of the remote. The DVR allows you to pause live TV for up to two hours. Trick-play features include 4-speed fast forward and reverse, skip back and forward, and slow-motion frame-by-frame and forward and reverse.

Digital Media Server

MediaPortal organizes and stores your entire personal digital media library on an internal hard drive. Browse and manage your digital music and photo collections using our intuitive remote-controlled user interface. The built-in DVD/CD drive lets you play, read and burn DVDs and CDs so you can easily add media to your library or take it with you for sharing or enjoying on the go. Because MediaPortal is connected to your home network, its built-in Web interface will let you listen to music and view your photos from any browser-enabled device in the home or you can enjoy your media remotely with Web Remote Access service.

Multi-Room Entertainment Networking

MediaPortal can support multiple televisions to distribute content throughout the home using our entertainment networking technology. Now you can watch recorded shows, order video-on-demand, listen to music, view photos, and even pause live TV in one room and resume watching in another. Expand your digital media library to include music and photos stored on any computer in the home using our media PC software.

Broadband Media Services

With your super-fast DSL connection you can conveniently and legally purchase and download movies and music with our on-demand media services—even purchase movie tickets. With the same simplicity, you can order prints of your favorite photos for yourself or send them to someone else. Share all of your digital memories with family and friends on your own personal Website. All of this can be done from the comfort of your sofa and with a press of your remote control.

Referring to FIGS. 7a-7c, although the impulse noise detection method 700 is shown in the form of a flow chart having separate blocks and arrows, the operations described in a single block do not necessarily constitute a process or function that is dependent on or independent of the other operations described in other blocks. Furthermore, the order in which the operations are described herein is merely illustrative, and not limiting, as to the order in which such operations may occur in alternate embodiments. For example, some of the operations described may occur in series, in parallel, or in an alternating and/or iterative manner. Another approach is also possible.

While some specific embodiments of the the invention have been shown the invention is not to be limited to these embodiments. The invention is to be understood as not limited by the specific embodiments described herein, but only by scope of the appended claims.

What is claimed is:

1. A method, comprising:
detecting for impulse noise present in a multiple tone system;
measuring values of peak error samples to determine an approximate magnitude of an average of peak error samples present on a transmission medium;
measuring an average error value of all error samples to determine a standard deviation of a Gaussian distribution of background noise; and
comparing an amount of peak error samples to a threshold value that is based upon a standard deviation derived from background noise to determine if impulse noise is present on a tone.

2. The method of claim 1, wherein comparing an amount of peak error samples further comprises:
comparing a frequency of error samples with a magnitude greater than the threshold value to determine if impulse noise is present.

3. The method of claim 2, wherein comparing the frequency further comprises:
counting a number of error samples with the magnitude greater than the threshold value that is based upon the standard deviation derived from the background noise.
calculating the frequency of these error samples with the magnitude greater than the threshold by dividing the number of error samples with the magnitude greater than the threshold over a total number of error samples detected; and
determining if the frequency of these error samples with the magnitude greater than the threshold is higher than a set point, then impulse noise is determined to be present on the first tone.

4. The method of claim 1, wherein comparing an amount of peak error samples further comprises:
comparing a magnitude of a Gaussian distribution of peak error samples to a magnitude of a Gaussian distribution of background noise error samples; and
determining if a ratio of peak error samples to background noise error samples is higher than a set point, then impulse noise is determined to be present on the first tone.

5. The method of claim 1, wherein comparing an amount of peak error samples further comprises:
comparing a distance between a Gaussian distribution of peak error samples to a threshold based on the standard deviation of the Gaussian distribution of background noise error samples; and
determining if the distance is high enough and the Gaussian distribution of peak error samples has a magnitude greater than a set point, then impulse noise is determined to be present.

6. The method of claim 1, further comprising:
determining values for the amount of peak error samples and the standard deviation of the Gaussian distribution of background noise error samples using a Gaussian-mixture model with a Maximum-Likelihood algorithm and an Expectation-Maximization algorithm.

7. The method of claim 1, further comprising:
using a Gaussian-mixture model with a Maximum-Likelihood algorithm and a set of assumptions to yield values for the Maximum-Likelihood algorithm to determine the values for the amount of peak error samples and the standard deviation of the Gaussian distribution of background noise error samples.

8. The method of claim 1, further comprising:
using a set of assumptions, including assuming that an impulse noise activation frequency is much higher than a target error rate and an average magnitude of peak error samples is at least two times greater than the standard deviation of the Gaussian distribution of background noise error samples, to determine values for the amount of peak error samples and the standard deviation of the Gaussian distribution of background noise error samples.

9. The method of claim 1, further comprising:
determining if the presence of impulse noise is detected on two or more tones transmitted on a same transmission medium, then declaring that an impulse noise source is associated with the transmission medium.

10. A machine readable medium storing instructions to cause the machine to perform the method of claim 1.

11. A machine readable medium storing instructions to cause the machine to perform the method of claim 8.

12. An apparatus, comprising:
means for detecting for impulse noise present in a multiple tone system;
means for measuring values of peak error samples to determine an approximate magnitude of an average of peak error samples present on a transmission medium;
means for measuring an average error value of all error samples to determine a standard deviation of a Gaussian distribution of background noise; and
means for comparing an amount of peak error samples to a threshold value that is based upon a standard deviation derived from background noise to determine if impulse noise is present on a first tone.

13. The apparatus of claim 12, further comprising:
means for comparing a magnitude of a Gaussian distribution of peak error samples to a magnitude of a Gaussian distribution of background noise error samples.

14. The apparatus of claim 12, further comprising:
means for determining values for the amount of peak error samples and the standard deviation of the Gaussian distribution of background noise error samples using a Gaussian-mixture model with a Maximum-Likelihood algorithm and an Expectation-Maximization algorithm.

15. The apparatus of claim 12, further comprising:
means for determining values for the amount of peak error samples and the standard deviation of the Gaussian distribution of background noise error samples using a Gaussian-mixture model with a Maximum-Likelihood algorithm and a set of assumptions to yield values for the Maximum-Likelihood algorithm.

16. The apparatus of claim 12, further comprising:
means for determining values for the amount of peak error samples and the standard deviation of the Gaussian distribution of background noise error samples using a set of assumptions, including assuming that an impulse noise activation frequency is much higher than a target error rate and an average magnitude of peak error samples is at least two times greater than the standard deviation of the Gaussian distribution of background noise error samples.

17. The apparatus of claim 12, further comprising:
means for determining if the presence of impulse noise is detected on two or more tones transmitted on a same transmission medium, then declaring that an impulse noise source is associated with the transmission medium.

18. A transmitter-receiver device, comprising:
a transmitter portion; and
a receiver portion having an impulse noise detector configured to detect an error difference between an amplitude of each transmitted data point and an expected amplitude for each data point in order to detect for the presence of impulse noise; wherein the error difference for each transmitted data point is an error sample.

19. The transmitter-receiver device of claim 18, wherein the impulse noise detector is configured to calculate a power of the error samples on each tone and sets a magnitude threshold for the error samples for each tone based upon a standard deviation for average power of Gaussian distribution of error samples of noise on that tone.

20. The transmitter-receiver device of claim 18, wherein the impulse noise detector is configured to count a number of error samples with a magnitude greater than the magnitude threshold value that is based upon the standard deviation derived from the background noise.

21. The transmitter-receiver device of claim 20, wherein the impulse noise detector is configured to calculate a frequency of the error samples with the magnitude greater than the threshold by dividing the number of error samples with the magnitude greater than the threshold over a total number of error samples detected.

22. The transmitter-receiver device of claim 21, wherein the impulse noise detector is configured to determine if he frequency of error samples with the magnitude greater than the threshold is higher than a set point, then an impulse noise is determined to be present on the first tone.

23. The transmitter-receiver device of claim 18, wherein the impulse noise detector is configured to determine if a number of tones having impulse noise present is greater than a tone count threshold, then declare that an impulse noise source is associated with a transmission medium.
